(19) United States
(12) Patent Application Publication
(10) Pub. No.: US 2020/0002069 A1
(43) Pub. Date: Jan. 2, 2020

(54) GREASE RESISTANT PAPERBOARD AND PIZZA BOX MADE THEREWITH

(71) Applicant: KRUGER HOLDINGS L.P., Montreal (CA)

(72) Inventor: Ian MACEACHEN, Montreal-Ouest (CA)

(21) Appl. No.: 16/455,023

(22) Filed: Jun. 27, 2019

Related U.S. Application Data
(60) Provisional application No. 62/691,273, filed on Jun. 28, 2018.

(51) Int. Cl. B65D 65/40; B65D 5/20; B65D 85/36; B32B 29/00; B32B 29/08

(52) U.S. Cl. CPC B65D 65/403; B65D 5/2052; A21D 13/41; B32B 29/005; B32B 29/08; B65D 85/36

(57) ABSTRACT

A paperboard assembly adapted for food contact comprises a contacting layer made of permeable material; an external layer; and a core layer located between the contacting layer and the external layer. The core layer is adapted to impede migration of fluid therethrough, therefore a fluid contacting the contacting layer migrates at least partially through the contacting layer and is impeded from reaching the external layer by the core layer. A describes realization is a pizza box made of the paperboard assembly and a method of manufacturing the paperboard assembly.

### CROSS-REFERENCE TO RELATED APPLICATION

This application claims priority from U.S. provisional patent application 62/691,273 filed Jun. 28, 2018, the specification of which is hereby incorporated herein by reference in its entirety.

### BACKGROUND

### (a) Field

The subject matter disclosed generally relates to paperboard material and paperboard products. More particularly, the subject matter disclosed relates to paperboard-based food containers and method of manufacturing the same.

### (b) Related Prior Art

In the field of food containers, a particular sub-category consists of food containers designed for transportation of hot, humid, greasy and oily products, such as hot food, with an example of such containers being pizza boxes. Specific requirements are associated with this sub-category since the food, e.g., the pizza, must be kept hot in the container while maintaining its characteristics in terms of texture for instance. This type of food being somewhat greasy, the food container must be adapted to handle the grease while keeping a pleasant aspect. Up to now, no existing containers, and more particularly food container such as pizza boxes corresponds to all the requirements of such a utilization.

There is therefore a need for improvement in the field of material for containers, containers, food containers, and particularly corrugated food containers for humid and/or greasy or oily content such as hot and greasy food and more specifically pizzas.

### SUMMARY

According to an embodiment, there is provided a paperboard assembly comprising: a contacting layer made of permeable material; an external layer; and a core layer located between the contacting layer and the external layer, the core layer having fluid-repellent characteristics impeding migration of fluid therethrough; wherein a fluid contacting the contacting layer of the paperboard assembly migrates at least partially through the contacting layer and is impeded from reaching the external layer by the core layer.

According to an aspect, the core layer comprises fluid-repellent compound.

According to an aspect, the fluid-repellent compound comprises a grease-repellent compound.

According to an aspect, the grease-repellent compound comprises Fluorinated polyether-urethane anionomer.

According to an aspect, the core layer comprises a sub-core layers, wherein at least one of one of the sub-core layers is a repellent sub-core layer impeding migration of fluid therethrough.

According to an aspect, the fluid-repellent characteristics are substantially homogeneous throughout the repellent sub-core layer.

According to an aspect, the core layer is corrugated.

According to an embodiment, there is provided a method of manufacturing grease-repellent paperboard on a paperboard machine comprising a press section, the method comprising: forming a first external layer on the paperboard machine; spraying a fluid-repellent compound on pulp used for forming a core layer after dewatering of the pulp thereof; forming the core layer from the sprayed pulp on the paperboard machine; forming a second external layer on the paperboard machine; and assembling the first external layer, the second external layer and the core layer in-between in the paperboard machine prior to assembling the first external layer, the core layer and the second external layer into the paperboard on the press section; whereby the paperboard thereby comprises a fluid-repellent core layer between two external layers, and wherein the core layer is adapted to impede migration of fluid therethrough.

According to an aspect, spraying a fluid-repellent compound on pulp comprises spraying a grease-repellent compound.

According to an aspect, the method further comprises processing the pulp with a couch roller, wherein the step of spraying the grease-repellent compound is performed before processing the pulp with the couch roller.

According to an aspect, the method further comprises generating a plurality of sub-layers from the pulp; and assembling the plurality of sub-layers into the core layer, wherein at least one of the sub-layers is sprayed with a grease-repellent compound.

According to an aspect, the method further comprises mechanically deforming or shaping the core layer.

According to an aspect, the method further comprises gluing the core layer to at least one of the first external layer and the second external layer.

According to an aspect, the method further comprises generating a grease-repellent compound comprising Fluorinated polyether-urethane anionomer.

According to an aspect, the step of generating the grease-repellent compound further comprises adding Ethylenediaminetetraacetic acid (EDTA).

According to an aspect, the step of generating the grease-repellent compound further comprises adding a biocide.

According to an aspect, the step of spraying the fluid-repellent compound comprises dosing an amount of between about 5 and 15 kg of grease-repellent compound per metric ton of produced paperboard.

According to an embodiment, there is provided a food package for containing food made of a paperboard assembly, the paperboard assembly comprising: a food-contacting layer, the food-contacting layer being permeable to fluid; an external layer; and a core layer made of paperboard having fluid repellent characteristics impeding fluid from the food from reaching the external layer; wherein the food-contacting layer, the core layer and the external layer are bonded together and shaped to form the food package.

According to an aspect, the core layer comprises corrugated paperboard.

According to an aspect, the food package defines an enclosure having a top and a bottom and wherein both the top and the bottom are made of a combination of the food-contacting layer, the core layer and the external layer.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a top plan view of a pizza box prior to being folded in accordance with an embodiment;

FIG. 2 is a perspective view of the pizza box of FIG. 1 in a folded, open state;

FIG. 3 is a perspective view of the pizza box of FIG. 1 in a folded, closed state;

FIG. 4A is a schematic representation showing a side view of a paperboard assembly comprising a corrugated core layer, wherein the paperboard assembly is used to make the pizza box of FIGS. 1 to 3;

FIG. 4B is a schematic representation showing a side view of a paperboard assembly comprising a non-corrugated core layer, wherein the paperboard assembly is used to make the pizza box of FIGS. 1 to 3; and

FIG. 5A-5D is a schematic diagram of a cylinder multi-ply paperboard machine for producing the core layer from which is made the core layer of the paperboard assembly of FIGS. 4A and 4B.

It will be noted that throughout the appended drawings, like features are identified by like reference numerals.

### DETAILED DESCRIPTION

Throughout the present document, one must note that the terms permeable, non-barrier and absorbent are intended to be synonyms or to describe similar or related characteristics of a material.

On the other hand, the terms, repellent and barrier and associated adjectives are intended to be interchangeable, as the adjective associated therewith.

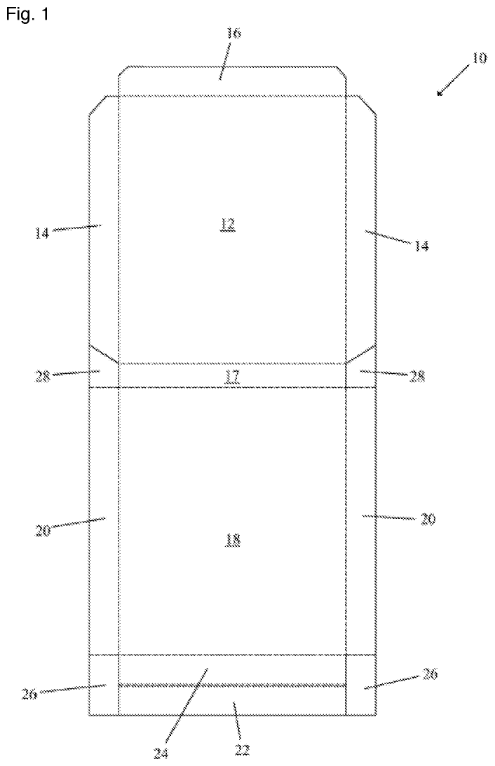

Referring now to the drawings, and more particularly to FIGS. 1 to 3, carry-out or delivery pizza is a popular consumer food product and is often served at parties or small gatherings. Carry-out or delivery pizza is also especially popular in association with particular events, such as birthdays and sporting events.

Carry-out or delivery pizza is usually transported in a pizza box. Pizza boxes are conventionally made of corrugated paperboard or paperboard assembly. Pizza boxes are available in different designs with one particular design shown in FIGS. 1 to 3. FIG. 1 shows a conventional pizza box 10 made according to an embodiment prior to being folded. Dashed lines represent fold lines to form a folded pizza box 10. Two side flaps 14 and a front flap 16 extend from the lid 12. The lid 12 is separated from the bottom 18 by a back wall 17. Two side walls 20 and a front wall, which is formed by an inner front wall 22 and an outer front wall 24 when the pizza box is folded, extend from the bottom 18. Tabs 28 on the back ends of the side walls 20 insert in front of the back wall 17 and tabs 26 on the front ends of the side walls 20 insert between the front walls 22, 24 in forming the folded pizza box.

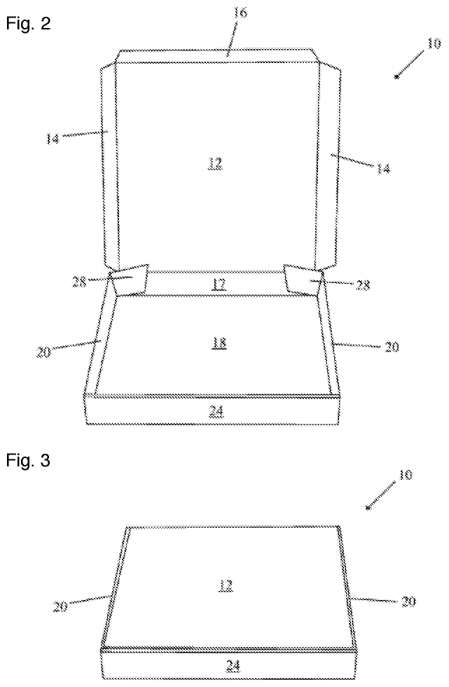

FIG. 2 shows the pizza box 10 of FIG. 1 in a folded, open state with the lid open. FIG. 3 shows the pizza box 10 in a folded, closed state with the lid closed.

Typically, pizza boxes 10 are made a single piece of paperboard assembly.

According to alternative embodiments, in addition to the basic features shown in FIGS. 1-3, pizza boxes may have additional holes, flaps, or tabs to make the pizza box sturdier, easier to open or close, or better at housing the pizza during transportation of the pizza from the pizza restaurant to the home of the consumer. Pizza boxes may further have a totally different design while being made of the paperboard assembly of the present subject-matter without departing from the scope of the present disclosure.

Pizza boxes also often feature prints over the exterior of the lid 12 or the bottom 18, such as advertisements, logos and information directed to the consumer of the pizza. Accordingly, pizza boxes need to allow printing over the exterior face of the pizza box 10 using conventional methods in order to keep the cost of production of these pizza boxes as low as possible.

Even though not limitative, typical pizza boxes 10 are made a single piece of paperboard assembly. It must be understood that both single-piece pizza boxes and pizza boxes made of assembled portions are intended to be covered by the present description.

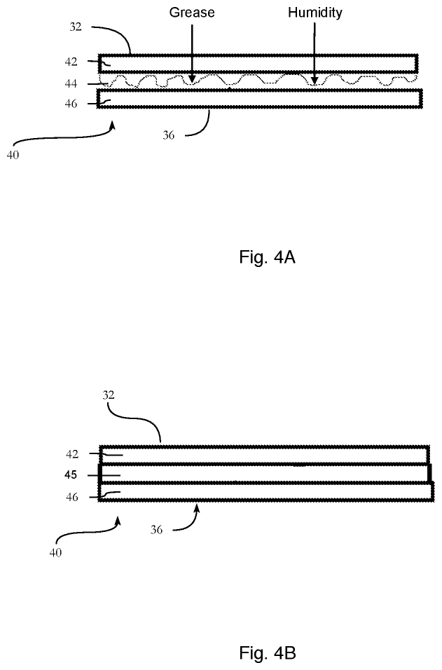

FIG. 4A shows the composition of the paperboard assembly 40 from which is made the pizza box 10. In the present description, the paperboard assembly 40 is used for all parts of the pizza box 10. However, the present disclosure also encompasses an embodiment in which the bottom 18 of the pizza box 10 is made from the paperboard assembly 40, with at least one of the other parts of the pizza box 10 being made of an alternative material, either an alternative paperboard or another material. Referring back to FIG. 4A, the paperboard assembly 40 comprises a top layer 42, a.k.a. a food-contacting layer, made of at least partially permeable, non-barrier or absorbent material. The top layer 42 forms an interior face 32 contacting the pizza in the pizza box 10.

The paperboard assembly 40 comprises a bottom layer 46. According to an embodiment, the bottom layer 46 features characteristics well adapted to the intended use of the pizza box 10, namely capability to print information thereon, a glossy finish, a desired esthetic, a desired texture, or a combination of the foregoing characteristics. The bottom layer 46 forms the exterior face 36 of the pizza box 10; the exterior face 36 being the one contacted by a user when handling the pizza box 10.

According to an embodiment, the core layer 44 is adapted to impede migration of the ink used to print on the bottom layer 46 and thus prevents the ink to reach the top layer 42.

The paperboard assembly 40 comprises a core layer 44 located between the top layer 42 and the bottom layer 46. The core layer 44 comprises a grease-repellent compound (aka fluid-repellent compound).

Accordingly, fluid, e.g., liquid, grease, oil, water, humidity or vapor from a hot and/or greasy product, such as a pizza, contacting the top layer 42 is at least partially absorbed by the top layer 42, migrating from the interior face 32 toward the exterior face 36. The core layer 44, comprising a grease-repellent compound, acts as a barrier preventing the fluid (humidity, grease and/or oil) to migrate through the core layer 44, keeping the nature and texture of the bottom layer 46 unaltered. Furthermore, the top layer 42, being made of permeable material, allows at least part of the fluid to migrate away from the interior face 32, thus preventing the pizza from becoming soggy from soaking in an excessive amount of grease, oil or humidity over time; e.g., the time of delivery of the pizza.

Accordingly, the design of the paperboard assembly 40 features the advantages that when liquid, e.g., liquid, grease, oil, water, humidity, or vapor, contacts the top layer 42 of the paperboard assembly 40, the fluid is at least partially absorbed in the top layer 42 and impeded from reaching the bottom layer 46 by the core layer 44.

According to an embodiment, the top layer 42 is made of a substantially flat paperboard, maximizing the surface of contact between the pizza and the top layer 42. According to an embodiment, using the pizza box 10 comprises, in some embodiments, laying down a food-contacting liner (not shown) over the top layer 42 before putting the pizza in the pizza box 10; the food-contacting liner having known permeable characteristics potentially improving the efficiency of the pizza box 10 in terms of resulting sogginess, aspect of the interior face 32 of the pizza box 10 once the pizza is removed, etc.

According to an embodiment, the top layer 42 comprises a single layer. According to another embodiment, the top layer 42 comprises a plurality of layers. According to an embodiment, the top layer is a porous paperboard featuring pores (not shown) from the interior face 32 to the core layer 44; the pores providing passages for the fluid away from the interior face 32. According to an embodiment (not shown), the top layer 42 comprises holes or punches of specific sizes for the fluid to migrates faster away from the interior face 32. According to an embodiment, the top layer 42 is free of holes or punches performed on the top layer 42. The size of the pores and/or holes are selected according to their desired impact in view of the fact that, in most realizations, the size of the pores or holes have smaller impact on the efficiency of the paperboard assembly 40 than the nature and quality of the top layer 42.

According to an embodiment, the permeable characteristics of the top layer 42 differ with respect to grease/oil and humidity. Accordingly, the speed of migration of the grease/oil in the top layer 42 differs from the speed of migration of the water/humidity in the top layer 42.

According to an embodiment, the bottom layer 46 is made of a substantially flat paperboard, facilitating the printing or application of glue over the exterior face 36 of the pizza box 10. According to an embodiment, the bottom layer 46 comprises one of more layers of paperboard, with the layers being laminated together when numerous.

According to an embodiment, the core layer 44 consists of a single layer of typically multi-ply corrugated paperboard forming part of the paperboard assembly 40 comprising the top layer 42, the core layer 44 and the bottom layer 46. The corrugated nature of the core layer 44 increases strength of the paperboard assembly 40 while providing areas for the fluid that migrates through the top layer 42 to stall. Thus, the selection of the best size of corrugation is based on the characteristics (strength) desired for the pizza box 10.

According to another embodiment, the core layer 44 consists of a multi-ply paperboard corrugated and further assembled with the top layer 42 and the bottom layer 46 in the paperboard assembly 40 of FIG. 4A. The top layer 42, the core layer 44 and the bottom layer 46 are bound together either mechanically, such as under pressure, chemically, such as using a glue (e.g., a starch-based glue) or compound to generate binding between the layers, or using a combination of the methods hereabove.

Therefore, according to an embodiment, a food package such as a pizza box 10 for containing food comprises a food-contacting layer (the top layer 42), an external layer (the bottom layer 46), and a core layer 44, made of corrugated paperboard defining a grease-barrier impeding grease from the food from reaching the bottom layer 46. During the manufacturing process of the food package, the top layer 42, the core layer 44 and the bottom layer 46 are bonded together to create the paperboard assembly 40. The resulting paperboard assembly 40 is then shaped to form the food package.

According to an embodiment, the shaping of the paperboard assembly 40 comprises at least one of folding, molding, cutting and gluing the paperboard assembly 40 into the shaped food package. Accordingly, one outcome of the use of such a paperboard assembly 40 resides in having the capability to make the pizza box 10 on a standard corrugator machine with regular glues and without affecting operational efficiencies.

Please note that for the description below the singular is used for easiness of description. The singular form is intended, unless explicitly described as otherwise, to describe both embodiments where a single component is present and a plurality of components operating in the same fashion are present.

Referring now to FIG. 4B, an embodiment of the paperboard assembly 40 comprises a top layer 42 made of permeable material, a non-corrugated paperboard, a.k.a. non-corrugated core layer 45, comprising a grease-repellent compound (aka fluid-repellent compound) acting as a barrier, and a bottom layer 46. According to an embodiment, the non-corrugated paperboard core layer 45 is made from the same type of paperboard as the corrugated paperboard of core layer 44 of FIG. 4A.

Back to the paperboard assembly 40 of FIG. 4B, the top layer 42, the non-corrugated paperboard core layer 45 and the bottom layer 46 are bound together either mechanically, such as under pressure, chemically, such as using a glue (e.g., a starch based glue) or compound to generate binding between the layers, or using a combination of the methods hereabove.

When in use, the top layer 42 of the pizza box 10 forms an interior face 32 contacting the pizza absorbing grease and humidity expelled from the pizza. One must understand that the embodiment of paperboard assembly 40 shown in FIGS. 4A and 4B mention a single top layer 42, a single middle or core layer 44 or 45 and a single bottom layer 46. However, each of these layers may be made of multi-layer paperboard, with at least one of the layers of the multi-layer paperboard featuring the described characteristics. According to embodiments, the layers of the multi-layer paperboard are assembled together for instance using a cylinder multi-ply paperboard machine or a fourdrinier-type multi-ply paperboard machine comprising a press section, or alternatively mechanically, chemically or via a combination of the methods thereof.

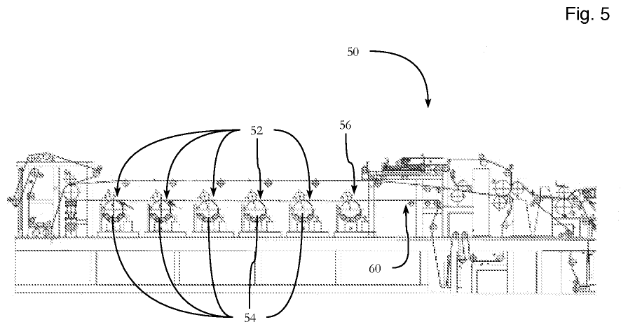

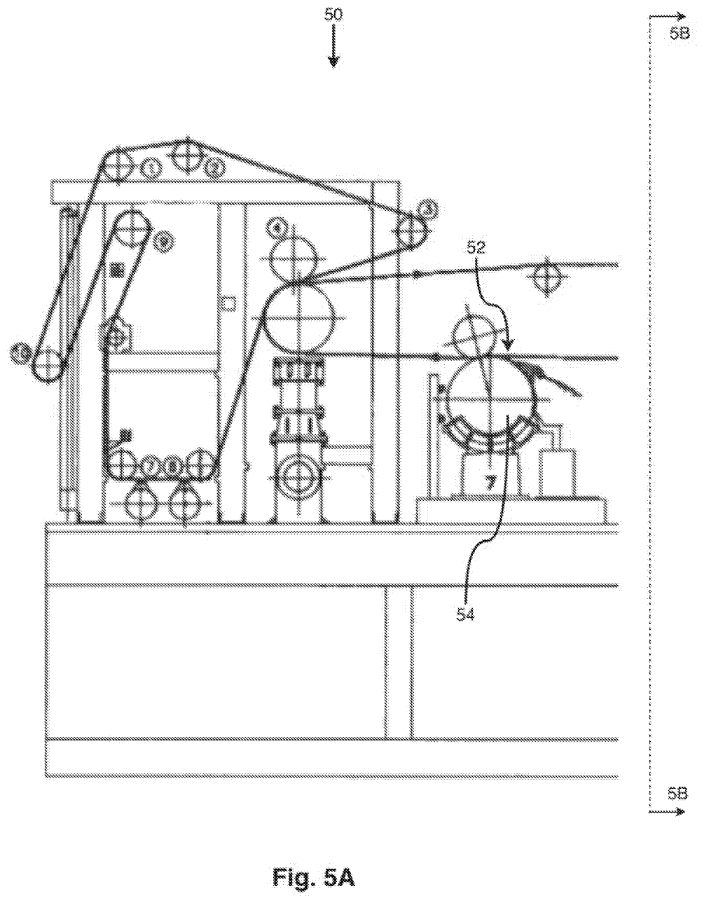

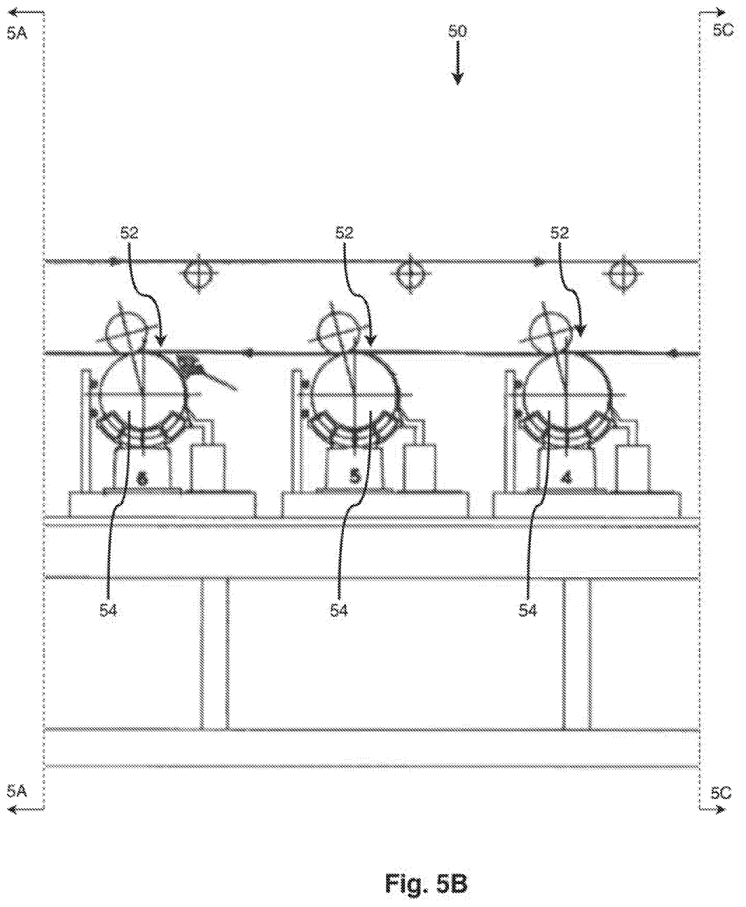

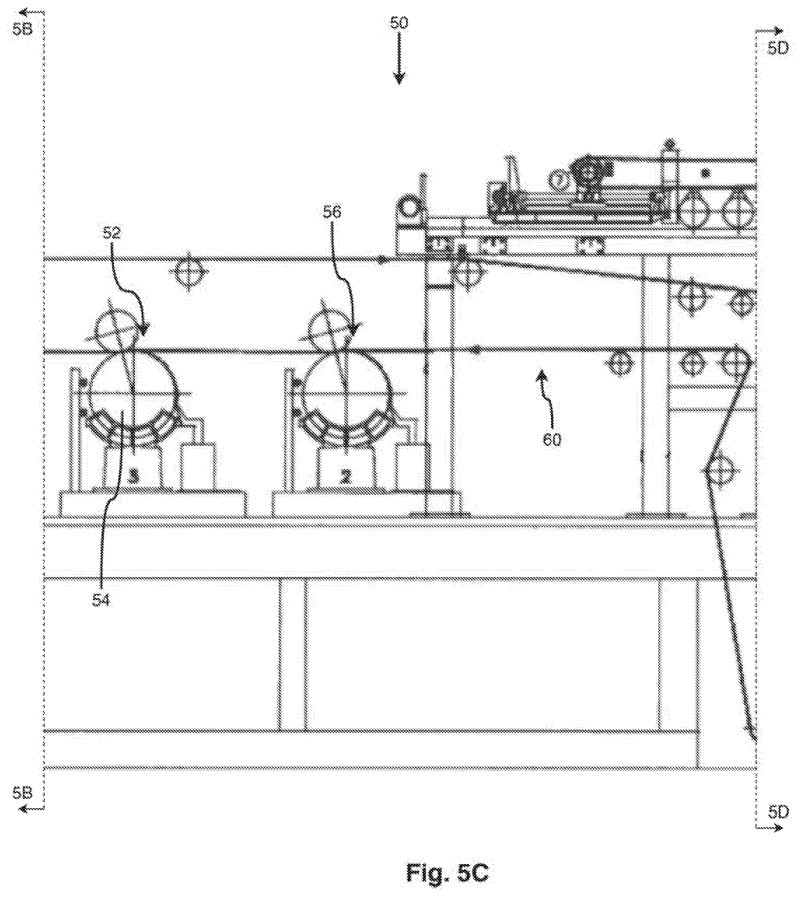

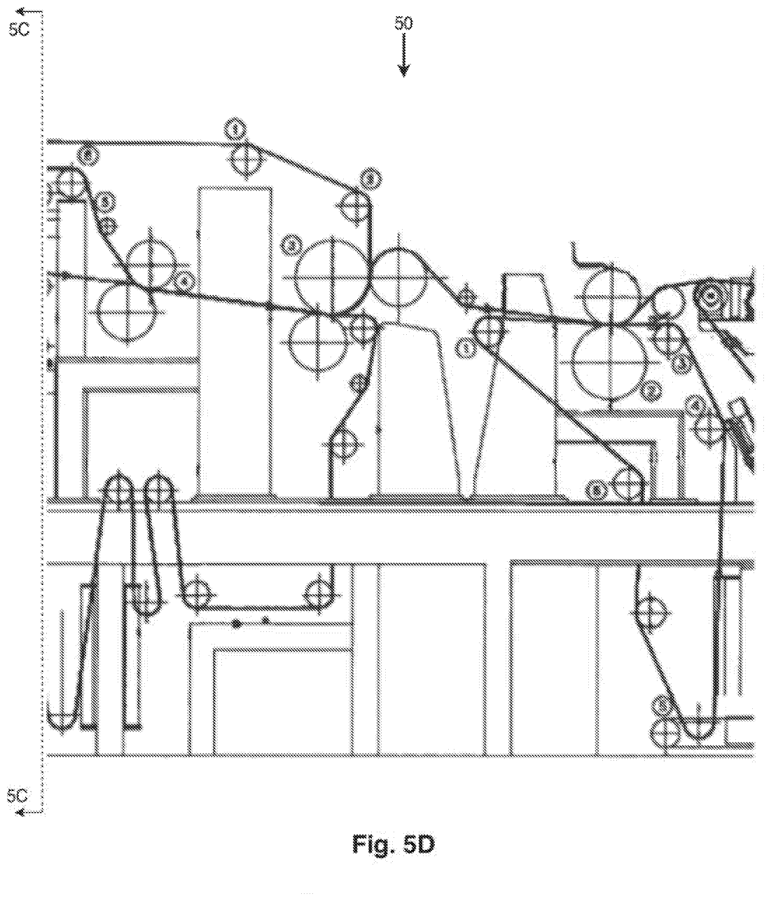

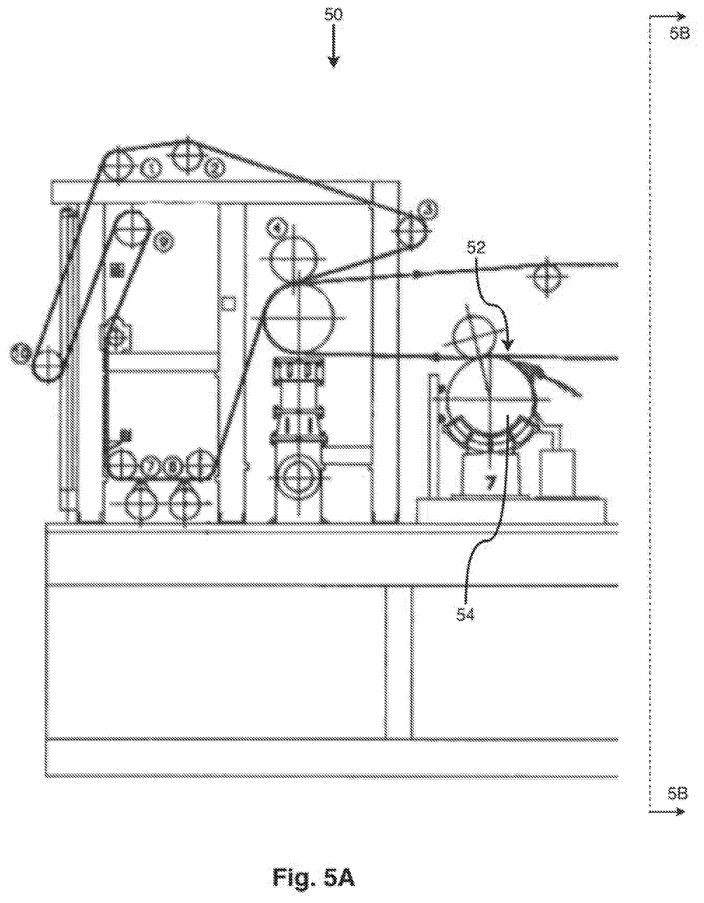

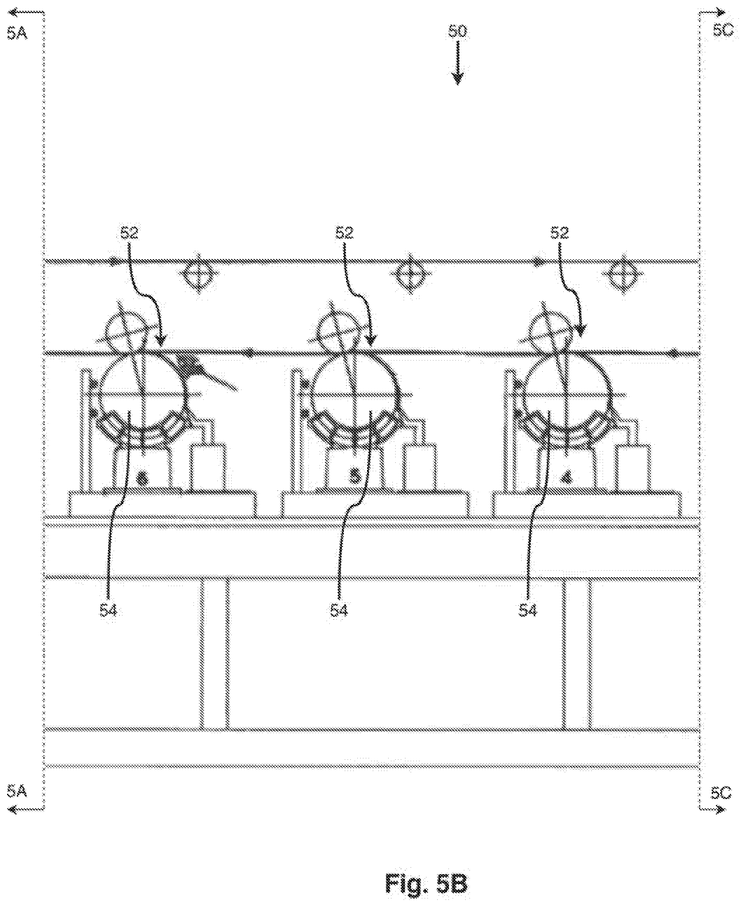

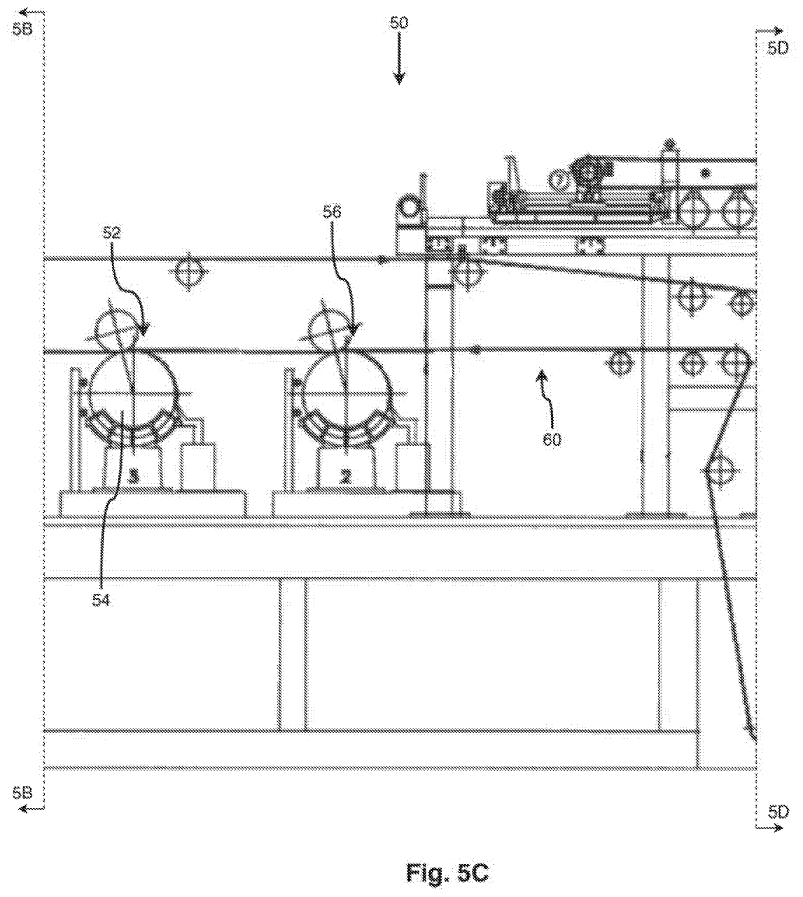

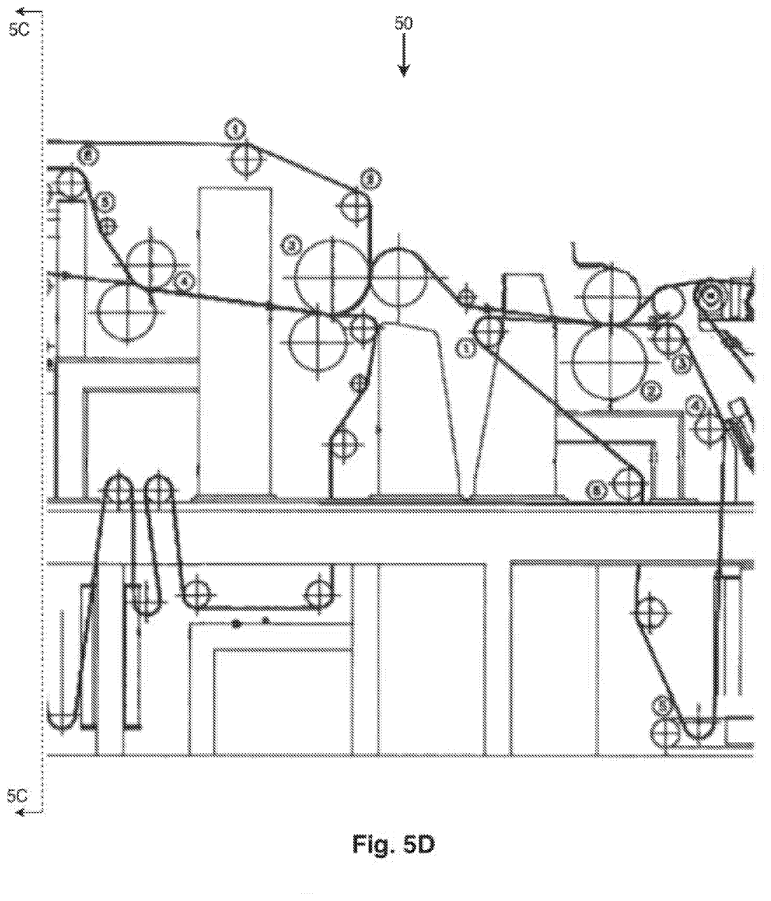

Now referring to FIG. 5A-5D, there is shown a cylinder multi-ply paperboard machine 50 for manufacturing paperboard made of a plurality of layers of paper according to a method comprising steps as discussed herein. Alternatively, the present method of manufacturing the core layer 44 could equally apply to a fourdrinier-type multiply paperboard machine (not shown), operating in a similar fashion as persons skilled in the art would know. The method involves spraying a grease repellent chemical additive onto the pulp layer 60 near the entrance into a couch roll 52, after the free water has been removed from the pulp layer 60, i.e., dewatering, on the drainage cylinder 54 or forming wire. According to embodiments, the grease repellent chemical is sprayed onto a variable number of pulp layers 60, on the condition that grease repellent chemical is not applied on the surface pulp layer, or in other words the pulp layer 60 forming the surface, of the manufactured paperboard. For example, the grease repellent chemical would not be applied about the couch roller 56.

According to embodiments, the core layer 44 is made of a plurality of sub-layers, i.e., sub-core layers, combined together to form the core layer 44.

According to an embodiment, the grease resistant chemical is pre-treated with other chemical additives to obtain the spray solution that will be sprayed on the pulp layers 60. The addition of other chemical additives in the spray solution aims to improve its retention on the fibers and to maximize grease repellent properties once added to the pulp, as well as complexing the calcium ions that would otherwise disactivate the grease resistant chemical.

According to an embodiment, the method further comprises corrugating the manufactured grease-repellent paperboard on a standard corrugating box making machine (not shown) using regular glues and with without significant loss of operating efficiency. The method also further comprises assembling the previously corrugated (or non-corrugated according to another embodiment) grease resistant paperboard (thus becoming the core layer 44) with a food-contacting layer (top layer 42) of flat paperboard that is permeable to fluid and a bottom layer 46, wherein the corrugated paperboard forming the core layer 44 is sandwiched between the food-contacting top layer 42 and the bottom layer 46.

According to an embodiment, the core layer 44 has a weight of about 161 to 205 g/m², corresponding to a thickness of about 180 μm to 280 μm. The thickness of the top layer 42 and the core layer 44 will typically be selected to respond to the strength against deformation desired for the pizza box 10. According to another embodiment, the core layer 44 has a weight of about 140 to 205 g/m² (when the core layer 44 is corrugated). When the core layer 45 is not corrugated, the weight is normally higher.

According to an embodiment, the grease-repellent compound is Fluorinated polyether-urethane anionomer, mixed with other ingredients to enhance its retention and grease repellent performance. According to an embodiment, the grease-barrier performance is sufficient for its intended applications, and its performance cannot be measured by the traditional KIT test (Tappi 559), or the Solvay proprietary NFA test, that are designed for surface applications of grease resistant barriers. According to an embodiment, the amount, i.e., dose, of grease-repellent compound sprayed is about 5 to 15 kg/mt (metric ton) based on the weight of the entire paperboard. In addition, water hardness in the shower water is eliminated with EDTA (Ethylenediaminetetraacetic acid) added at 0.1 to 0.4%, and cationic starch or an acrylamide copolymer is added in a ratio of 0.1 to 0.5% on the Fluorinated polyether-urethane anionomer to enhance retention, without causing uneven spraying issues. As well, the papermaking process is treated with a biocide to maximize process pH and reduce hardness.

According to an embodiment, the core layer 44 is made of relative homogeneous material, treated pulp, thereby the grease-repellent characteristics, i.e., part of the physical characteristics, of the core layer 44 are substantially homogeneous and/or constant throughout the resulting core layer 44 rather than limited to the surface of the core layer 44 as would result from a coated material.

According to an embodiment, the top layer 42 and bottom layer 46 of the manufactured paperboard is pulp, untreated with or grease chemical additives, and suitable for gluing on a conventional corrugating machine.

According to an embodiment, the top layer 42 has a high-water resistance with Tappi Cobb 30 minute-levels of down to about 0.8 g/cm² to resist moisture penetration through the layer. According to another embodiment, the top layer 42 has a high level of absorbency with Tappi water tests of a few seconds to remove moisture from the food article on the surface of the top layer 42.

According to an embodiment, the food-contacting top layer 42 may be composed of recycled or virgin fibers, per the application. The core layer 44/45 is made of recycled fibers, and the bottom layer 46 can be composed of recycled or virgin fibers per the application.

A central feature of the present paperboard assembly 40 comprising the grease-repellent core layer 44/45 resides in the capacity of this product to be converted (corrugated and glued) on a conventional corrugator machine. This solution depends at least in part in grease-barrier be glueable and not subject to breakdown on the corrugating machine due to the nature of the paperboard assembly 40.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A paperboard assembly comprising:
a contacting layer made of permeable material;
an external layer; and
a core layer located between the contacting layer and the external layer, the core layer having fluid-repellent characteristics impeding migration of fluid therethrough;
wherein a fluid contacting the contacting layer of the paperboard assembly migrates at least partially through the contacting layer and is impeded from reaching the external layer by the core layer.

2. The paperboard assembly of claim 1, wherein the core layer comprises fluid-repellent compound.

3. The paperboard assembly of claim 2, wherein the fluid-repellent compound comprises a grease-repellent compound.

4. The paperboard assembly of claim 3, wherein the grease-repellent compound comprises Fluorinated polyether-urethane anionomer.

5. The paperboard assembly of claim 1, wherein the core layer comprises a sub-core layers, wherein at least one of one of the sub-core layers is a repellent sub-core layer impeding migration of fluid therethrough.

6. The paperboard assembly of claim 5, wherein the fluid-repellent characteristics are substantially homogeneous throughout the repellent sub-core layer.

7. The paperboard assembly of claim 1, wherein the core layer is corrugated.

8. A method of manufacturing grease-repellent paperboard on a paperboard machine comprising a press section, the method comprising:
forming a first external layer on the paperboard machine;
spraying a fluid-repellent compound on pulp used for forming a core layer after dewatering of the pulp thereof;
forming the core layer from the sprayed pulp on the paperboard machine;
forming a second external layer on the paperboard machine; and
assembling the first external layer, the second external layer and the core layer in-between in the paperboard machine prior to assembling the first external layer, the core layer and the second external layer into the paperboard on the press section;
whereby the paperboard thereby comprises a fluid-repellent core layer between two external layers, and
wherein the core layer is adapted to impede migration of fluid therethrough.

9. The method of claim 8, wherein spraying a fluid-repellent compound on pulp comprises spraying a grease-repellent compound.

10. The method of claim 9, further comprising processing the pulp with a couch roller, wherein the step of spraying the grease-repellent compound is performed before processing the pulp with the couch roller.

11. The method of claim 8, further comprising generating a plurality of sub-layers from the pulp; and
assembling the plurality of sub-layers into the core layer,
wherein at least one of the sub-layers is sprayed with a grease-repellent compound.

12. The method of claim 8, further comprising mechanically deforming or shaping the core layer.

13. The method of claim 8, further comprising gluing the core layer to at least one of the first external layer and the second external layer.

14. The method of claim 8, further comprising generating a grease-repellent compound comprising Fluorinated polyether-urethane anionomer.

15. The method of claim 14, wherein the step of generating the grease-repellent compound further comprises adding Ethylenediaminetetraacetic acid (EDTA).

16. The method of claim 14, wherein the step of generating the grease-repellent compound further comprises adding a biocide.

17. The method of claim 8, wherein the step of spraying the fluid-repellent compound comprises dosing an amount of between about 5 and 15 kg of grease-repellent compound per metric ton of produced paperboard.

18. A food package for containing food made of a paperboard assembly, the paperboard assembly comprising:
a food-contacting layer, the food-contacting layer being permeable to fluid;
an external layer; and
a core layer made of paperboard having fluid repellent characteristics impeding fluid from the food from reaching the external layer;
wherein the food-contacting layer, the core layer and the external layer are bonded together and shaped to form the food package.

19. The food package of claim 18, wherein the core layer comprises corrugated paperboard.

20. The food package of claim 18, wherein the food package defines an enclosure having a top and a bottom and wherein both the top and the bottom are made of a combination of the food-contacting layer, the core layer and the external layer.
